(19) United States
(12) Patent Application Publication
(10) Pub. No.: US 2024/0320127 A1
(43) Pub. Date: Sep. 26, 2024

(54) EVENT TRACING

(71) Applicant: SiFive, Inc., Santa Clara, CA (US)

(72) Inventors: Bruce Ableidinger, San Mateo, CA (US); Ernest L. Edgar, San Mateo, CA (US)

(73) Assignee: SiFive, Inc., Santa Clara, CA (US)

(21) Appl. No.: 18/733,046

(22) Filed: Jun. 4, 2024

Related U.S. Application Data
(63) Continuation of application No. PCT/US2022/051787, filed on Dec. 5, 2022.
(60) Provisional application No. 63/286,517, filed on Dec. 6, 2021.

(51) Int. Cl. G06F 11/36

(52) U.S. Cl. CPC G06F 11/3636

(57) ABSTRACT

Systems and methods are disclosed for debug event tracing. For example, an integrated circuit (e.g., a processor) for executing instructions includes a processor core; a data store configured to store a code indicating a cause of an interrupt; a trace buffer configured to store a sequence of debug trace messages; and a debug trace circuitry that is configured to: responsive to a first interrupt to the processor core, generate a first debug trace message including a timestamp and a code from the data store that indicates a cause of the first interrupt; and store the first debug trace message in the trace buffer. In some implementations, the timestamp is generated using a Gray code counter of the integrated circuit.

### CROSS-REFERENCES TO RELATED APPLICATIONS

This application is a continuation of International Application No. PCT/US2022/051787, filed Dec. 5, 2022, which claims priority to U.S. Provisional application Ser. No. 63/286,517, filed Dec. 6, 2021, the entire contents of which are incorporated herein by reference for all purposes.

### FIELD OF TECHNOLOGY

This disclosure relates to event tracing in a processor.

### BACKGROUND

Integrated circuits for executing instructions (e.g., processors or microcontrollers) often include a debug port that enables a host device (e.g., a personal computer or laptop) to communicate with each other via a set of conductors (e.g., providing a serial port). For example, a host device may connect to the debug interface of an integrated circuit using a debug probe (e.g., a Joint Test Action Group (JTAG) probe). For example, the debug interface may be used by a host device to write input data (e.g., firmware images and/or debug commands) to the integrated circuit and read output data (e.g., register values or other memory contents) from the integrated circuit.

### BRIEF DESCRIPTION OF THE DRAWINGS

The disclosure is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity.

FIG. 1 is a block diagram of an example of a system for debugging an integrated circuit for executing instructions.

FIG. 2 is a block diagram of an example of an integrated circuit for executing instructions that includes a debug trace circuit configured to generate messages stored in a trace buffer.

FIG. 3 is a block diagram of an example of a hardware configuration of a computing device.

FIG. 4 is a flow chart of an example of a process for generating a debug

event trace with Gray coded timestamps.

FIG. 5 is a flow chart of an example of a process for generating a debug event trace with cause codes for interrupts.

FIG. 6 is a flow chart of an example of a process for generating a debug event trace with events for watchpoints.

FIG. 7 is a flow chart of an example of a process for generating a debug event trace with instrumented trace capability.

FIG. 8 is a flow chart of an example of a process for generating a debug event trace with external triggers for trace messages.

FIG. 9 is a block diagram of an example of a system for facilitating generation and manufacture of integrated circuits.

### DETAILED DESCRIPTION

Systems and methods are described herein that may be used to implement event tracing in a processor. Debug event messages may be generated and stored in a trace buffer on an integrated circuit to await potential retrieval by a host device that is being used to debug software running on one or more processor cores of the integrated circuit. The host device may be running debug software that receives, decodes, and presents information from the debug trace messages in a user interface for a user that is developing software to run on the integrated circuit.

The debug trace messages may be generated in response to the occurrence of various events during the execution of instructions by the one or more processor cores. For example, a debug trace message may be generated responsive to an interrupt. An interrupt may be a hardware interrupt (e.g., from a peripheral on the integrated circuit or an external device via an interrupt request line) or a software interrupt (e.g., an exception or a trap). A debug trace message for an interrupt may include a code that indicates a cause of the interrupt that has occurred. For example, a cause code may indicate an exception type for the interrupt. For example, a cause code may identify a peripheral of the integrated circuit or an interrupt request line that raised the interrupt. Other types of events may trigger the generation of debug trace messages, such as a branch instruction being taken, an instruction matching a watchpoint being executed, a write to a register in a set of instrumented trace registers, or an external trigger from peripheral of the integrated circuit (e.g., a bus controller or a direct memory access controller).

In some implementations, the debug trace messages include timestamps that are encoded with a Gray code. Gray codes have the property that only one bit changes between consecutive integers as they are represented using the Gray code. Using a Gray code to encode the timestamps may reduce or eliminate the chance of timestamp errors caused by transient states of a counter as bits flip at slightly different times.

The debug event tracing techniques described may provide advantages over conventional debug tracing techniques, such as, for example, more efficiently encoding control flow of software running on an integrated circuit for storage in trace buffer and transfer to a host. This may serve to reduce the size of trace buffer and/or increase the number of instructions that can effectively traced with a given trace buffer size.

As used herein, the term “circuitry” refers to an arrangement of electronic components (e.g., transistors, resistors, capacitors, and/or inductors) that is structured to implement one or more functions. For example, a circuit may include one or more transistors interconnected to form logic gates that collectively implement a logical function.

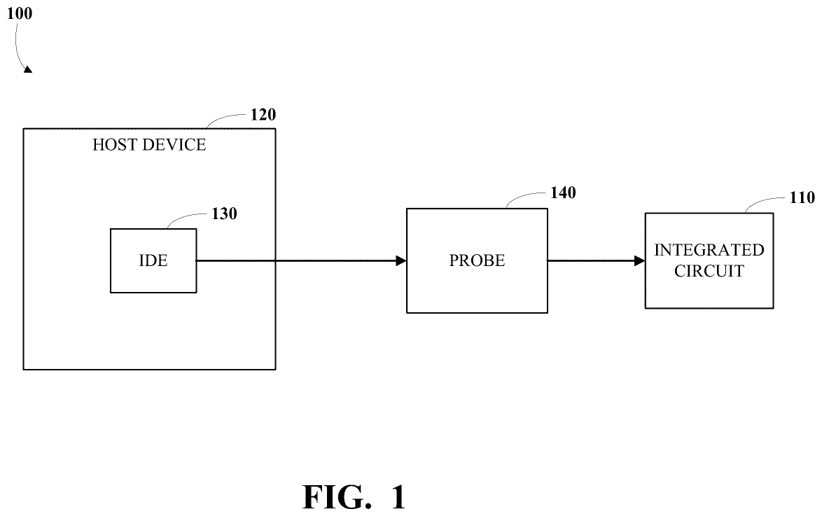

FIG. 1 is a block diagram of an example of a system 100 for debugging an integrated circuit 110 for executing instructions. The system 100 include the integrated circuit 110 and a host device 120 (e.g., a personal computer, such as a laptop) that will connect to the integrated circuit 110 to send and receive data, such as data to facilitate debugging of software (e.g., firmware) that will be executed by the integrated circuit 110. The host device 120 includes integrated development environment (IDE) software 130 (e.g., Eclipse) that runs on the host device 120. The host device 120 may be configured to access (e.g., using the integrated development environment software 130) the integrated circuit 110 via a probe (e.g., a JTAG compliant probe) that connects the host device 120 to the integrated circuit 110. In some implementations (not shown in FIG. 1), the host device may connect directly to the integrated circuit 110 (e.g., via a passive cable including conductors corresponding the conductors of a debug interface of the integrated circuit 110.

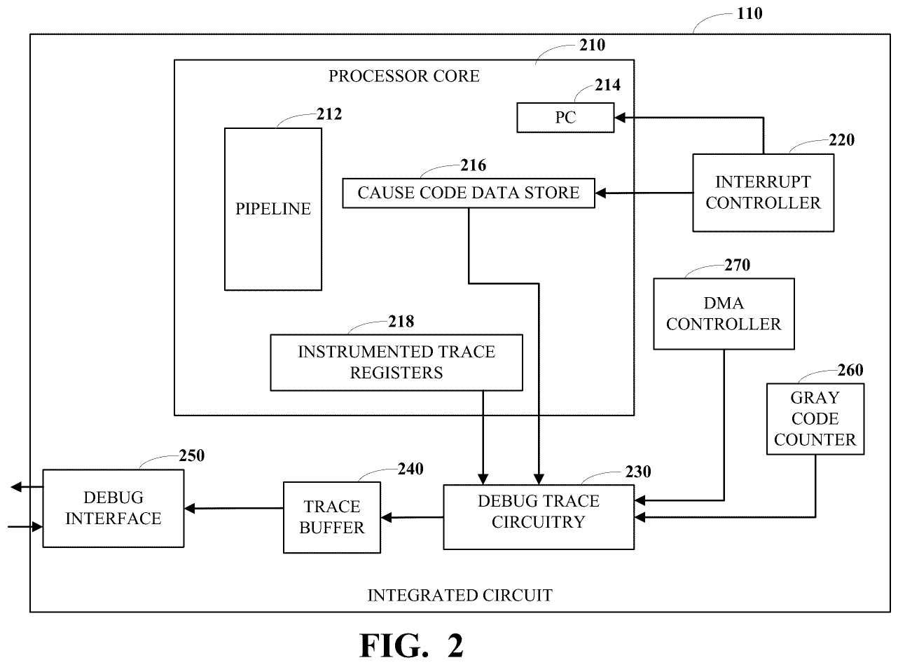

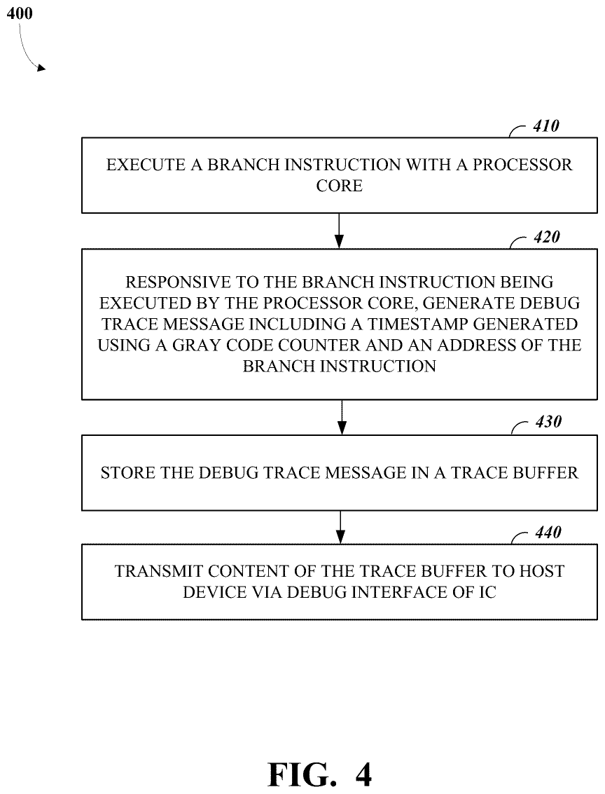

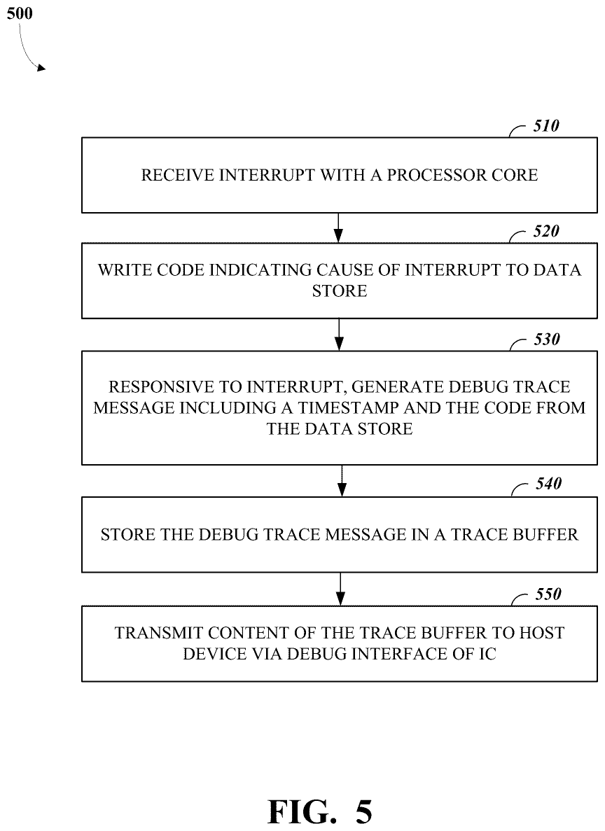

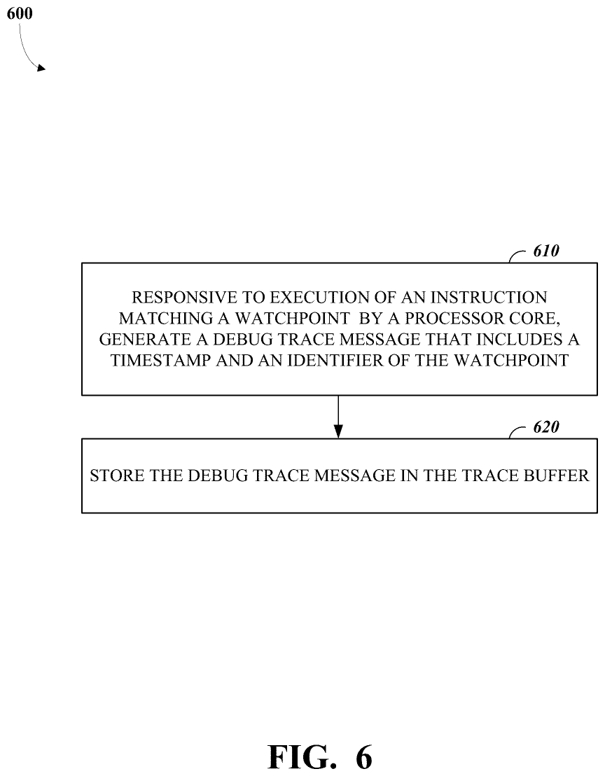

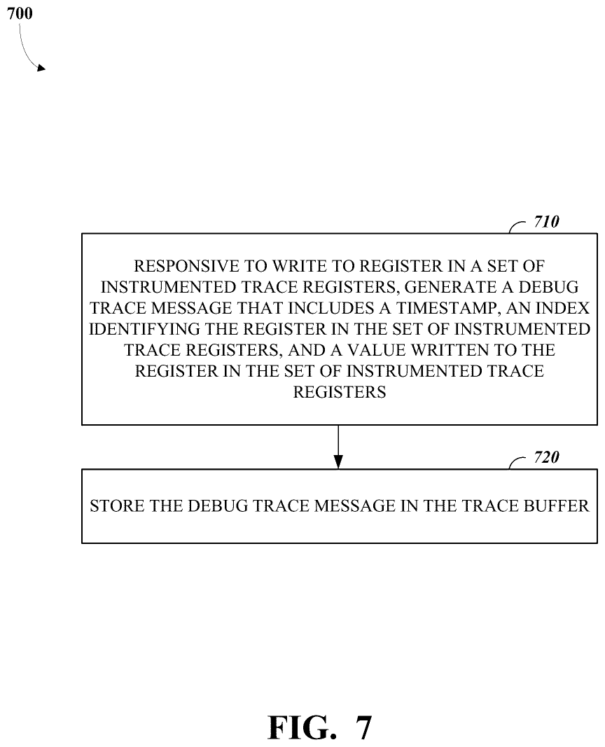

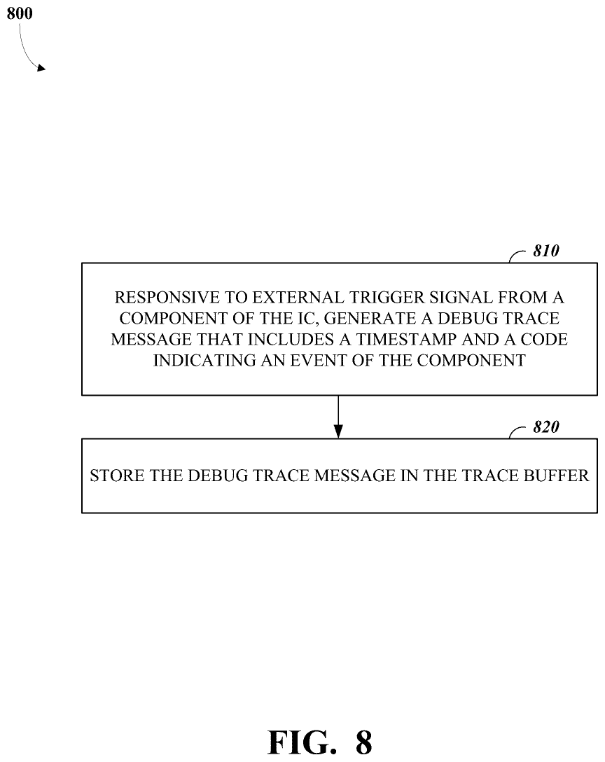

FIG. 2 is a block diagram of an example of an integrated circuit 110 for executing instructions that includes a debug trace circuitry 230 configured to generate messages stored in a trace buffer 240. For example, the integrated circuit 110 may be a microprocessor, a microcontroller, or another integrated circuit configured to execute instructions. The integrated circuit 110 includes a processor core 210 (e.g., an IP core or a hart), including a processor pipeline 212, a program counter register 214, a cause code data store 216, and a set of instrumented trace registers 218. The integrated circuit 110 also includes an interrupt controller 220, a debug trace circuitry 230, a trace buffer 240, a debug interface 250, a Gray code counter 260, and a direct memory access (DMA) controller 270. For example, the integrated circuit may be configured to implement the process 400 of FIG. 4, the process 500 of FIG. 5, the process 600 of FIG. 6, the process 700 of FIG. 7, and/or the process 800 of FIG. 8.

The integrated circuit 110 includes a processor core 210 configured to execute instructions (e.g., RISC-V instructions, ARM instructions, or x86 instructions). In some implementations, although not shown in FIG. 2, the integrated circuit 110 includes multiple processor cores. The processor core 210 includes a processor pipeline 212 configured to execute instructions, including control flow instructions (e.g., branch instructions). The pipeline 212 includes one or more fetch stages that are configured to retrieve instructions from a memory system of the integrated circuit 110. For example, the pipeline 212 may fetch instructions via an L1 instruction cache. The pipeline 212 may include additional stages, such as decode, rename, dispatch, issue, execute, memory access, and write-back stages. For example, the pipeline 212 may read and write data via an L1 data cache. For example, the processor core 210 may include a pipeline 212 configured to execute instructions of a RISC-V instruction set.

The processor core 210 includes data storage circuitry that is configured to store an architectural state and a microarchitectural state of the processor core 210. The processor core 210 includes a program counter register 214 that is configured to store an address of a next instruction to be fetched from the memory system and executed by the pipeline 212. The processor core 210 includes a cause code data store 216 configured to store a code indicating a cause of an interrupt. For example, the cause code data store 216 may be a register of the processor core 210. In some implementations, the code stored in the cause code data store 216 may be updated by an interrupt controller 220 when an interrupt is issued to the processor core 210. An interrupt may be a hardware interrupt (e.g., from a peripheral on the integrated circuit 110 or an external device via an interrupt request line) or a software interrupt (e.g., an exception or a trap). For example, the code stored in the cause code data store 216 may indicate an exception type. For example, the code stored in the cause code data store 216 may identify a peripheral of the integrated circuit or an interrupt request line that raised the interrupt.

The processor core 210 includes a set of instrumented trace registers 218. A write to a register in the set of instrumented trace registers 218 may trigger generation of a debug trace message including the updated content that has been written to the register. For example, the set of instrumented trace registers 218 may be used to provide a data channel to enable software running on the processor core 210 transfer data to a host via the trace buffer 240.

The integrated circuit 110 includes an interrupt controller 220 that is configured to issue hardware interrupts to the processor core 210 and possibly other processor cores of the integrated circuit 110. For example, the interrupt controller 220 may route interrupts from peripherals (e.g., the DMA controller 270) of the integrated circuit 110 and/or other external hardware connected to interrupt request lines of the integrated circuit 110 to the processor core 210. In some implementations, the interrupt control 220, upon receiving a hardware interrupt, updates the program counter register 214 to the address of an interrupt handling routine configured for the hardware interrupt and also updates a value stored in the cause code data store 216 to include a code indicating the cause of the hardware interrupt. In some implementations, software interrupts (e.g., exceptions and traps) may also update a code stored in the cause code data store 216.

The integrated circuit 110 includes a debug trace circuitry 230 configured to generate debug trace messages. For example, the debug trace may be an event-based trace that generates debug trace messages responsive to control flow changes in the code running on the processor core 210, such as, function calls, returns, and/or interrupts (e.g., hardware interrupts, exceptions, or traps). In some implementations, debug trace messages may be generated when branch instructions are taken. The debug trace messages may include respective timestamps. For example, a timestamp for a debug trace message may be generated using the Gray code counter 260, which may help to prevent timestamp errors due to transient states of the counter, since a Gray code counter only changes a single bit when transitioning between consecutive numbers. The debug trace circuitry 230 may be configured to store a debug trace message it generates in the trace buffer 240. In some implementations, the branch instruction is a function call or a return and the debug trace circuitry 230 is configured to ignore other types of branch instructions.

The trace buffer 240 may be configured to store a sequence of debug trace messages. For example, the trace buffer may include static random access memory (SRAM). In some implementations a portion of an SRAM or another data store on the integrated circuit 110 is reserved for use as the trace buffer 240.

The integrated circuit 110 includes a debug interface 250 comprising two or more conductors (e.g., conductors of a JTAG interface) with input/output drivers configured to, when enabled, transmit and receive signals between the processor core 210 and an external host device (e.g., the host device 120) via the two or more conductors. For example, the debug interface 250 may be compliant with a standard, such as the RISC-V debug specification. In some implementations, the integrated circuit 110 is configured to transmit contents of the trace buffer 240 to a host device (e.g., the host device 120) via the debug interface 250 of the integrated circuit 110.

For example, the debug trace circuitry 230 may be configured to, responsive to a first interrupt to the processor core 210, generate a first debug trace message including a timestamp and a code from the data store 216 that indicates a cause of the first interrupt. The debug trace circuitry 230 may store the first debug trace message in the trace buffer 240.

In some implementations, the debug trace circuitry 230 is configured to, responsive to execution of an instruction matching a watchpoint by the processor core 210, generate a second debug trace message that includes a timestamp and an identifier of the watchpoint. The debug trace circuitry 230 may store the second debug trace message in the trace buffer 240.

For example, the debug trace circuitry 230 may be configured to, responsive to a write to a register in the set of instrumented trace registers 218, generate a third debug trace message that includes a timestamp, an index identifying the register in the set of instrumented trace registers 218, and a value written to the register in the set of instrumented trace registers 218. The debug trace circuitry 230 may store the third debug trace message in the trace buffer 240.

In some implementations, the debug trace circuitry 230 may be configured to, responsive to an external trigger signal from a component of the integrated circuit 110 outside of the processor core 210, generate a fourth debug trace message that includes a timestamp and a code indicating an event of the component. For example, the component may be a direct memory access controller 270 and the event may be a start of a data transfer operation by the component. For example, the component may be a bus controller and the event may be a bus error. The debug trace circuitry 230 may store the fourth debug trace message in the trace buffer 240.

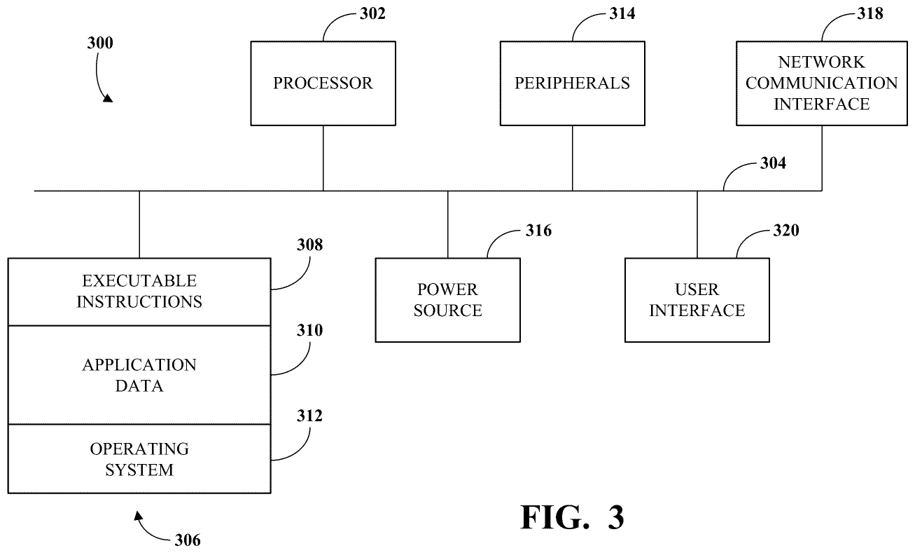

FIG. 3 is a block diagram of an example of a hardware configuration of a computing device 300, which may be used to implement a host device (e.g., the host device 120 shown in FIG. 1). The computing device 300 can include components or units, such as a processor 302, a bus 304, a memory 306, peripherals 314, a power source 316, a network communication interface 318, a user interface 320, other suitable components, or a combination thereof.

The processor 302 can be a central processing unit (CPU), such as a microprocessor, and can include single or multiple processors having single or multiple processing cores. Alternatively, the processor 302 can include another type of device, or multiple devices, now existing or hereafter developed, capable of manipulating or processing information. For example, the processor 302 can include multiple processors interconnected in any manner, including hardwired or networked, including wirelessly networked. In some implementations, the operations of the processor 302 can be distributed across multiple physical devices or units that can be coupled directly or across a local area or other suitable type of network. In some implementations, the processor 302 can include a cache, or cache memory, for local storage of operating data or instructions.

The memory 306 can include volatile memory, non-volatile memory, or a combination thereof. For example, the memory 306 can include volatile memory, such as one or more DRAM modules such as double data rate (DDR) SDRAM, and non-volatile memory, such as a disk drive, a solid state drive, flash memory, Phase-Change Memory (PCM), or any form of non-volatile memory capable of persistent electronic information storage, such as in the absence of an active power supply. The memory 306 can include another type of device, or multiple devices, now existing or hereafter developed, capable of storing data or instructions for processing by the processor 302. The processor 302 can access or manipulate data in the memory 306 via the bus 304. Although shown as a single block in FIG. 3, the memory 306 can be implemented as multiple units. For example, a computing device 300 can include volatile memory, such as RAM, and persistent memory, such as a hard drive or other storage.

The memory 306 can include executable instructions 308, data, such as application data 310, an operating system 312, or a combination thereof, for immediate access by the processor 302. The executable instructions 308 can include, for example, one or more application programs, which can be loaded or copied, in whole or in part, from non-volatile memory to volatile memory to be executed by the processor 302. The executable instructions 308 can be organized into programmable modules or algorithms, functional programs, codes, code segments, or combinations thereof to perform various functions described herein. For example, the executable instructions 308 can include instructions of an integrated development environment software 130. For example, the executable instructions 308 can include instructions executable by the processor 302 to cause the computing device 300 to access data in the trace buffer 240 of an integrated circuit 110 via the debug interface 250 of the integrated circuit 110 and display information from the trace buffer in a graphical user interface. The application data 310 can include, for example, user files, database catalogs or dictionaries, configuration information or functional programs, such as a web browser, a web server, a database server, or a combination thereof. The operating system 312 can be, for example, Microsoft Windows®, Mac OS X®, or Linux®; an operating system for a small device, such as a smartphone or tablet device; or an operating system for a large device, such as a mainframe computer. The operating system 312 could also be an RTOS (Real-Time OS) such a FreeRTOS, ThreadX, VxWorks, Nucleus, or Zephyr. The memory 306 can comprise one or more devices and can utilize one or more types of storage, such as solid state or magnetic storage.

The peripherals 314 can be coupled to the processor 302 via the bus 304. For example, the peripherals 314 can include a serial port configured to communicate with a debug probe (e.g., the probe 140). The peripherals 314 can include sensors or detectors, or devices containing any number of sensors or detectors, which can monitor the computing device 300 itself or the environment around the computing device 300. For example, a computing device 300 can contain a temperature sensor for measuring temperatures of components of the computing device 300, such as the processor 302. Other sensors or detectors can be used with the computing device 300, as can be contemplated. In some implementations, the power source 316 can be a battery, and the computing device 300 can operate independently of an external power distribution system. Any of the components of the computing device 300, such as the peripherals 314 or the power source 316, can communicate with the processor 302 via the bus 304.

The network communication interface 318 can also be coupled to the processor 302 via the bus 304. In some implementations, the network communication interface 318 can comprise one or more transceivers. The network communication interface 318 can, for example, provide a connection or link to a network via a network interface, which can be a wired network interface, such as Ethernet, or a wireless network interface. For example, the computing device 300 can communicate with other devices via the network communication interface 318 and the network interface using one or more network protocols, such as Ethernet, TCP, IP, power line communication (PLC), WiFi, infrared, GPRS, GSM, CDMA, or other suitable protocols.

A user interface 320 can include a display; a positional input device, such as a mouse, touchpad, touchscreen, or the like; a keyboard; or other suitable human or machine interface devices. The user interface 320 can be coupled to the processor 302 via the bus 304. Other interface devices that permit a user to program or otherwise use the computing device 300 can be provided in addition to or as an alternative to a display. In some implementations, the user interface 320 can include a display, which can be a liquid crystal display (LCD), a cathode-ray tube (CRT), a light emitting diode (LED) display (e.g., an OLED display), or other suitable display. In some implementations, a client or server can omit the peripherals 314. The operations of the processor 302 can be distributed across multiple clients or servers, which can be coupled directly or across a local area or other suitable type of network. The memory 306 can be distributed across multiple clients or servers, such as network-based memory or memory in multiple clients or servers performing the operations of clients or servers. Although depicted here as a single bus, the bus 304 can be composed of multiple buses, which can be connected to one another through various bridges, controllers, or adapters.

FIG. 4 is a flow chart of an example of a process 400 for generating a debug event trace with Gray coded timestamps. The process 400 includes, executing 410 a branch instruction with a processor core; responsive to the branch instruction being executed by a processor core, generating 420 a first debug trace message including a timestamp generated using a Gray code counter and an address of the branch instruction; storing 430 the first debug trace message in a trace buffer; and transmitting 440 contents of the trace buffer to a host device via a debug interface of the integrated circuit. For example, process 400 may be implemented using the integrated circuit 110.

The process 400 includes executing 410 a branch instruction with a processor core (e.g., the processor core 210). The branch instruction may change the control flow of a program by changing a program counter value (e.g., the value stored in the program counter register 214). For example, the branch instruction may be conditional or unconditional. For example, the branch instruction may be direct, indirect, or relative.

The process 400 includes, responsive to the branch instruction being executed by the processor core, generating 420 a first debug trace message including a timestamp generated using a Gray code counter and an address of the branch instruction. The Gray code counter (e.g., the Gray code counter 260) may help to prevent timestamp errors due to transient states of the counter, since a Gray code counter only changes a single bit when transitioning between consecutive numbers. The address of the branch instruction may be an where the branch instruction is stored in memory or a target address of branch instruction that is used to redirect control flow. The address may be encoded in a variety of formats, such as direct, indirect, or relative. In some implementations, the first debug trace message is generated 420 responsive to the branch instruction be taken and changing a program counter.

In some implementations, the branch instruction is a function call or a return, and the process 400 includes ignoring other types of branch instructions as triggers for generating debug trace messages. Focusing debug trace resources on the function calls and returns may reduce resource consumption (e.g., reducing the size of a trace buffer) while still providing useful insight into the most important events during execution.

In some implementations, the first debug trace message includes one or more performance counter values. For example, the performance counter values may include counts of instructions executed, specific types of instructions executed such as loads or stores, cache misses (e.g., for an instruction cache and/or for a data cache), cycles consumed by cache misses, translation lookaside buffer (TLB) misses, cycles consumed by TLB misses, and/or processor stalls. In some implementations, the performance counters may be delta counters meaning they are cleared to zero when they are stored in the trace. For example, the performance counters may be encoded in a floating point format (e.g., with 12 bits of mantissa and 4 bits of exponent) to enable dynamic scaling. For example, the performance counters may be saturation counters.

The process 400 includes storing 430 the first debug trace message in a trace buffer (e.g., the trace buffer 240). The trace buffer may be configured to store a sequence debug trace messages to await potential retrieval by a host device. For example, the trace buffer may be implemented with SRAM. In some implementations, the trace buffer is implemented as a circular buffer that stores a set of most recent debug trace messages.

The process 400 includes transmitting 440 contents of the trace buffer to a host device via a debug interface (e.g., the debug interface 250) of the integrated circuit. The host device (e.g., the host device 120) may run software (e.g., the integrated development environment software 130) that is configured to receive, decode, and display information from the trace debug messages, including the first trace debug message to a user (e.g., via a graphical user interface).

Although not shown in FIG. 4, the process may also include the generation of additional debug trace messages responsive to various events occurring during execution of instructions by the processor core. For example, the process 400 may include the process 600 of FIG. 6, the process 700 of FIG. 7, and/or the process 800 of FIG. 8.

FIG. 5 is a flow chart of an example of a process 500 for generating a debug event trace with cause codes for interrupts. The process 500 includes receiving 510 a first interrupt with a processor core; writing 520 a code indicating a cause of the first interrupt to a data store; responsive to the first interrupt, generating 530 a first debug trace message including a timestamp and the code from the data store that indicates the cause of the first interrupt; storing 540 the first debug trace message in a trace buffer; and transmitting 550 contents of the trace buffer to a host device via a debug interface of an integrated circuit including the processor core. For example, process 500 may be implemented using the integrated circuit 110.

The process 500 includes receiving 510 first interrupt with a processor core (e.g., the processor core 210). For example, the first interrupt may be a hardware interrupt (e.g., from a peripheral on an integrated circuit or an external device via an interrupt request line) or a software interrupt (e.g., an exception or a trap). In some implementations, the first interrupt is received 510 from a system level interrupt controller (e.g., the interrupt controller 220) of an integrated circuit including the processor core. In some implementations, the first interrupt is received 510 from microarchitectural logic of the processor core in response to a trap or exception.

The process 500 includes writing 520 a code indicating a cause of the first interrupt to a data store (e.g., the cause code data store 216). For example, the cause code data store may be a register of the processor core. In some implementations, the code may be written 520 by an interrupt controller (e.g., the interrupt controller 220) when an interrupt is issued to the processor core. For example, the code may indicate an exception type. For example, the code may identify a peripheral of the integrated circuit or an interrupt request line that raised the first interrupt.

The process 500 includes, responsive to the first interrupt, generating 530 a first debug trace message including a timestamp and the code from the data store that indicates the cause of the first interrupt. For example, the timestamp may be encoded using a Gray code. Using a Gray code may reduce or eliminate the possibility of timestamp errors due to transient states of the counter, since a Gray code counter only changes a single bit when transitioning between consecutive numbers.

In some implementations, the first debug trace message includes one or more performance counter values. For example, the performance counter values may include counts of instructions executed, specific types of instructions executed such as loads or stores, cache misses (e.g., for an instruction cache and/or for a data cache), cycles consumed by cache misses, translation lookaside buffer (TLB) misses, cycles consumed by TLB misses, and/or processor stalls. In some implementations, the performance counters may be delta counters meaning they are cleared to zero when they are stored in the trace. For example, the performance counters may be encoded in a floating point format (e.g., with 12 bits of mantissa and 4 bits of exponent) to enable dynamic scaling. For example, the performance counters may be saturation counters.

The process 500 includes storing 540 the first debug trace message in a trace buffer (e.g., the trace buffer 240). The trace buffer may be configured to store a sequence debug trace messages to await potential retrieval by a host device. For example, the trace buffer may be implemented with SRAM. In some implementations, the trace buffer is implemented as a circular buffer that stores a set of most recent debug trace messages.

The process 500 includes transmitting 550 contents of the trace buffer to a host device via a debug interface (e.g., the debug interface 250) of an integrated circuit including the processor core. The host device (e.g., the host device 120) may run software (e.g., the integrated development environment software 130) that is configured to receive, decode, and display information from the trace debug messages, including the first trace debug message to a user (e.g., via a graphical user interface).

Although not shown in FIG. 5, the process 500 may also include the generation of additional debug trace messages responsive to various events occurring during execution of instructions by the processor core. For example, the process 500 may include the process 600 of FIG. 6, the process 700 of FIG. 7, and/or the process 800 of FIG. 8.

FIG. 6 is a flow chart of an example of a process 600 for generating a debug event trace with events for watchpoints. The process 600 includes, responsive to execution of an instruction matching a watchpoint by a processor core (e.g., the processor core 210), generating 610 a second debug trace message that includes a timestamp and an identifier of the watchpoint. A watchpoint is hardware that compares a user-set value to instruction addresses as they are executed. When a match occurs between the user-set value and an executed instruction address, the Event Trace hardware records the occurrence of the watchpoint in the form of its identifier (ID) (e.g., a value from 0 to 15). A timestamp of the time duration since the last trace message may also be recorded. In some implementations, the watchpoint may be a conditional breakpoint or a data breakpoint. For example, the watchpoint may be triggered by conditions, such as the reading, writing, or modification of a specific location in an area of memory. In some implementations, the timestamp is encoded using a Gray code. The process 600 includes storing 620 the second debug trace message in a trace buffer (e.g., the trace buffer 240). For example, process 600 may be implemented using the integrated circuit 110.

In some implementations, the second debug trace message includes one or more performance counter values. For example, the performance counter values may include counts of instructions executed, specific types of instructions executed such as loads or stores, cache misses (e.g., for an instruction cache and/or for a data cache), cycles consumed by cache misses, translation lookaside buffer (TLB) misses, cycles consumed by TLB misses, and/or processor stalls. In some implementations, the performance counters may be delta counters meaning they are cleared to zero when they are stored in the trace. For example, the performance counters may be encoded in a floating point format (e.g., with 12 bits of mantissa and 4 bits of exponent) to enable dynamic scaling. For example, the performance counters may be saturation counters.

FIG. 7 is a flow chart of an example of a process 700 for generating a debug event trace with instrumented trace capability. The process 700 includes, responsive to a write to a register in a set of instrumented trace registers (e.g., the set of instrumented trace registers 218), generating 710 a second debug trace message that includes a timestamp, an index identifying the register in the set of instrumented trace registers, and a value written to the register in the set of instrumented trace registers. In some implementations, the timestamp is encoded using a Gray code. The process 700 includes storing 720 the second debug trace message in a trace buffer (e.g., the trace buffer 240). For example, the set of instrumented trace registers may be used to provide a data channel to enable software running on a processor core (e.g., the processor core 210) to transfer data to a host device (e.g., the host device 120) via the trace buffer. For example, process 700 may be implemented using the integrated circuit 110.

In some implementations, the second debug trace message includes one or more performance counter values. For example, the performance counter values may include counts of instructions executed, specific types of instructions executed such as loads or stores, cache misses (e.g., for an instruction cache and/or for a data cache), cycles consumed by cache misses, translation lookaside buffer (TLB) misses, cycles consumed by TLB misses, and/or processor stalls. In some implementations, the performance counters may be delta counters meaning they are cleared to zero when they are stored in the trace. For example, the performance counters may be encoded in a floating point format (e.g., with 12 bits of mantissa and 4 bits of exponent) to enable dynamic scaling. For example, the performance counters may be saturation counters.

FIG. 8 is a flow chart of an example of a process 800 for generating a debug event trace with external triggers for trace messages. The process 800 includes, responsive to an external trigger signal from a component of an integrated circuit including a processor core that is outside of the processor core, generating 810 a second debug trace message that includes a timestamp and a code indicating an event of the component. For example, the component may be a direct memory access controller and the event may be a start of a data transfer operation by the component. For example, the event may be an end of a data transfer operation by the component. In some implementations, the component is a bus controller and the event is a bus error. In some implementations, the timestamp is encoded using a Gray code. The process 800 includes storing 820 the second debug trace message in a trace buffer (e.g., the trace buffer 240). For example, process 800 may be implemented using the integrated circuit 110.

In some implementations, the second debug trace message includes one or more performance counter values. For example, the performance counter values may include counts of instructions executed, specific types of instructions executed such as loads or stores, cache misses (e.g., for an instruction cache and/or for a data cache), cycles consumed by cache misses, translation lookaside buffer (TLB) misses, cycles consumed by TLB misses, and/or processor stalls. In some implementations, the performance counters may be delta counters meaning they are cleared to zero when they are stored in the trace. For example, the performance counters may be encoded in a floating point format (e.g., with 12 bits of mantissa and 4 bits of exponent) to enable dynamic scaling. For example, the performance counters may be saturation counters.

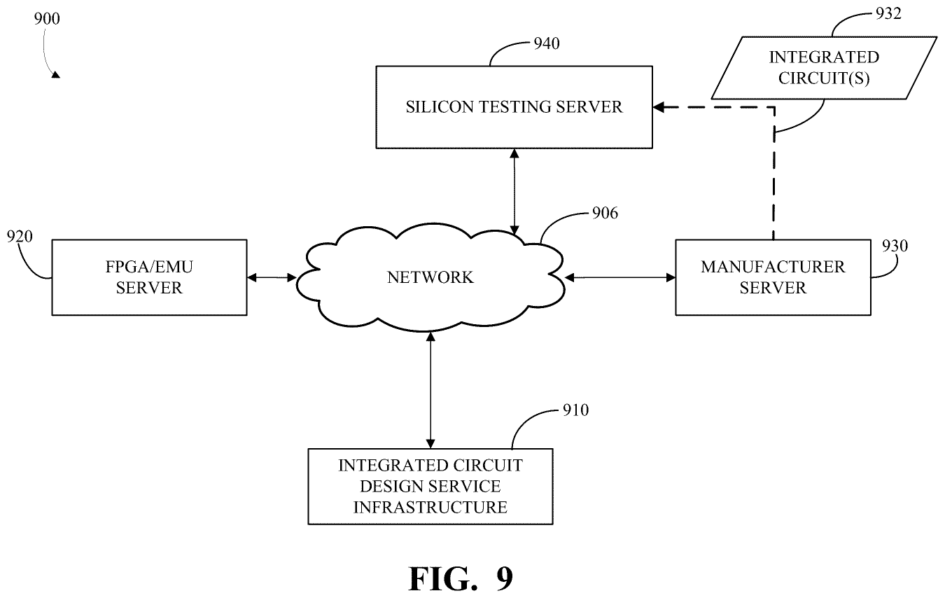

FIG. 9 is block diagram of an example of a system 900 for generation and manufacture of integrated circuits. The system 900 includes a network 906, an integrated circuit design service infrastructure 910, a field programmable gate array (FPGA)/emulator server 920, and a manufacturer server 930. For example, a user may utilize a web client or a scripting API client to command the integrated circuit design service infrastructure 910 to automatically generate an integrated circuit design based a set of design parameter values selected by the user for one or more template integrated circuit designs. In some implementations, the integrated circuit design service infrastructure 910 may be configured to generate an integrated circuit design that includes the circuitry shown and described in FIG. 2.

The integrated circuit design service infrastructure 910 may include a register-transfer level (RTL) service module configured to generate an RTL data structure for the integrated circuit based on a design parameters data structure. For example, the RTL service module may be implemented as Scala code. For example, the RTL service module may be implemented using Chisel. For example, the RTL service module may be implemented using flexible intermediate representation for register-transfer level (FIRRTL) and/or a FIRRTL compiler. For example, the RTL service module may be implemented using Diplomacy. For example, the RTL service module may enable a well-designed chip to be automatically developed from a high-level set of configuration settings using a mix of Diplomacy, Chisel, and FIRRTL. The RTL service module may take the design parameters data structure (e.g., a java script object notation (JSON) file) as input and output an RTL data structure (e.g., a Verilog file) for the chip.

In some implementations, the integrated circuit design service infrastructure 910 may invoke (e.g., via network communications over the network 906) testing of the resulting design that is performed by the FPGA/emulation server 920 that is running one or more FPGAs or other types of hardware or software emulators. For example, the integrated circuit design service infrastructure 910 may invoke a test using a field programmable gate array, programmed based on a field programmable gate array emulation data structure, to obtain an emulation result. The field programmable gate array may be operating on the FPGA/emulation server 920, which may be a cloud server. Test results may be returned by the FPGA/emulation server 920 to the integrated circuit design service infrastructure 910 and relayed in a useful format to the user (e.g., via a web client or a scripting API client).

The integrated circuit design service infrastructure 910 may also facilitate the manufacture of integrated circuits using the integrated circuit design in a manufacturing facility associated with the manufacturer server 930. In some implementations, a physical design specification (e.g., a graphic data system (GDS) file, such as a GDS II file) based on a physical design data structure for the integrated circuit is transmitted to the manufacturer server 930 to invoke manufacturing of the integrated circuit (e.g., using manufacturing equipment of the associated manufacturer). For example, the manufacturer server 930 may host a foundry tape out website that is configured to receive physical design specifications (e.g., as a GDSII file or an OASIS file) to schedule or otherwise facilitate fabrication of integrated circuits. In some implementations, the integrated circuit design service infrastructure 910 supports multi-tenancy to allow multiple integrated circuit designs (e.g., from one or more users) to share fixed costs of manufacturing (e.g., reticle/mask generation, and/or shuttles wafer tests). For example, the integrated circuit design service infrastructure 910 may use a fixed package (e.g., a quasi-standardized packaging) that is defined to reduce fixed costs and facilitate sharing of reticle/mask, wafer test, and other fixed manufacturing costs. For example, the physical design specification may include one or more physical designs from one or more respective physical design data structures in order to facilitate multi-tenancy manufacturing.

In response to the transmission of the physical design specification, the manufacturer associated with the manufacturer server 930 may fabricate and/or test integrated circuits based on the integrated circuit design. For example, the associated manufacturer (e.g., a foundry) may perform optical proximity correction (OPC) and similar post-tapeout/pre-production processing, fabricate the integrated circuit(s) 932, update the integrated circuit design service infrastructure 910 (e.g., via communications with a controller or a web application server) periodically or asynchronously on the status of the manufacturing process, perform appropriate testing (e.g., wafer testing), and send to packaging house for packaging. A packaging house may receive the finished wafers or dice from the manufacturer and test materials and update the integrated circuit design service infrastructure 910 on the status of the packaging and delivery process periodically or asynchronously. In some implementations, status updates may be relayed to the user when the user checks in using the web interface and/or the controller might email the user that updates are available.

In some implementations, the resulting integrated circuits 932 (e.g., physical chips) are delivered (e.g., via mail) to a silicon testing service provider associated with a silicon testing server 940. In some implementations, the resulting integrated circuits 932 (e.g., physical chips) are installed in a system controlled by silicon testing server 940 (e.g., a cloud server) making them quickly accessible to be run and tested remotely using network communications to control the operation of the integrated circuits 932. For example, a login to the silicon testing server 940 controlling a manufactured integrated circuits 932 may be sent to the integrated circuit design service infrastructure 910 and relayed to a user (e.g., via a web client). For example, the integrated circuit design service infrastructure 910 may control testing of one or more integrated circuits 932, which may be structured based on an RTL data structure.

The computing device 300 of FIG. 3 may be used to implement the integrated circuit design service infrastructure 910, and/or to generate a file that generates a circuit representation of an integrated circuit design including the circuitry shown and described in FIG. 2.

A non-transitory computer readable medium may store a circuit representation that, when processed by a computer, is used to program or manufacture an integrated circuit. For example, the circuit representation may describe the integrated circuit specified using a computer readable syntax. The computer readable syntax may specify the structure or function of the integrated circuit or a combination thereof. In some implementations, the circuit representation may take the form of a hardware description language (HDL) program, a register-transfer level (RTL) data structure, a flexible intermediate representation for register-transfer level (FIRRTL) data structure, a Graphic Design System II (GDSII) data structure, a netlist, or a combination thereof. In some implementations, the integrated circuit may take the form of a field programmable gate array (FPGA), application specific integrated circuit (ASIC), system-on-a-chip (SoC), or some combination thereof. A computer may process the circuit representation in order to program or manufacture an integrated circuit, which may include programming a field programmable gate array (FPGA) or manufacturing an application specific integrated circuit (ASIC) or a system on a chip (SoC). In some implementations, the circuit representation may comprise a file that, when processed by a computer, may generate a new description of the integrated circuit. For example, the circuit representation could be written in a language such as Chisel, an HDL embedded in Scala, a statically typed general purpose programming language that supports both object-oriented programming and functional programming.

In an example, a circuit representation may be a Chisel language program which may be executed by the computer to produce a circuit representation expressed in a FIRRTL data structure. In some implementations, a design flow of processing steps may be utilized to process the circuit representation into one or more intermediate circuit representations followed by a final circuit representation which is then used to program or manufacture an integrated circuit. In one example, a circuit representation in the form of a Chisel program may be stored on a non-transitory computer readable medium and may be processed by a computer to produce a FIRRTL circuit representation. The FIRRTL circuit representation may be processed by a computer to produce an RTL circuit representation. The RTL circuit representation may be processed by the computer to produce a netlist circuit representation. The netlist circuit representation may be processed by the computer to produce a GDSII circuit representation. The GDSII circuit representation may be processed by the computer to produce the integrated circuit.

In another example, a circuit representation in the form of Verilog or VHDL may be stored on a non-transitory computer readable medium and may be processed by a computer to produce an RTL circuit representation. The RTL circuit representation may be processed by the computer to produce a netlist circuit representation. The netlist circuit representation may be processed by the computer to produce a GDSII circuit representation. The GDSII circuit representation may be processed by the computer to produce the integrated circuit. The foregoing steps may be executed by the same computer, different computers, or some combination thereof, depending on the implementation.

In a first aspect, the subject matter described in this specification can be embodied in an integrated circuit for executing instructions that includes a processor core configured to execute instructions; a data store configured to store a code indicating a cause of an interrupt; a trace buffer configured to store a sequence of debug trace messages; and a debug trace circuitry that is configured to: responsive to a first interrupt to the processor core, generate a first debug trace message including a timestamp and a code from the data store that indicates a cause of the first interrupt; and store the first debug trace message in the trace buffer. In the first aspect, the integrated circuit may include a Gray code counter and the timestamp may be generated using the Gray code counter. In the first aspect, the data store may be a register of the processor core. In the first aspect, the trace buffer may be SRAM. In the first aspect, the debug trace circuitry may be configured to: responsive to execution of an instruction matching a watchpoint by the processor core, generate a second debug trace message that includes a timestamp and an identifier of the watchpoint; and store the second debug trace message in the trace buffer. In the first aspect, the integrated circuit may include a set of instrumented trace registers, and the debug trace circuitry may be configured to: responsive to a write to a register in the set of instrumented trace registers, generate a second debug trace message that includes a timestamp, an index identifying the register in the set of instrumented trace registers, and a value written to the register in the set of instrumented trace registers; and store the second debug trace message in the trace buffer. In the first aspect, the debug trace circuitry may be configured to: responsive to an external trigger signal from a component of the integrated circuit outside of the processor core, generate a second debug trace message that includes a timestamp and a code indicating an event of the component; and store the second debug trace message in the trace buffer. For example, the component may be a direct memory access controller and the event may be a start of a data transfer operation by the component. In the first aspect, the component may be a bus controller and the event be a bus error. In the first aspect, the integrated circuit may be configured to: transmit contents of the trace buffer to a host device via a debug interface of the integrated circuit. In the first aspect, the first debug trace message may include one or more performance counter values. The performance counter values may include a count of instructions executed. In the first aspect, the performance counters may be encoded in a floating point format.

In a second aspect, the subject matter described in this specification can be embodied in methods that include receiving a first interrupt with a processor core; writing a code indicating a cause of the first interrupt to a data store; responsive to the first interrupt, generating a first debug trace message including a timestamp and the code from the data store that indicates the cause of the first interrupt; and storing the first debug trace message in a trace buffer. In the second aspect, the timestamp may be encoded using a Gray code. In the second aspect, the data store may be a register of the processor core. In the second aspect, the method may include, responsive to execution of an instruction matching a watchpoint by the processor core, generating a second debug trace message that includes a timestamp and an identifier of the watchpoint; and storing the second debug trace message in the trace buffer. In the second aspect, the method may include, responsive to a write to a register in a set of instrumented trace registers, generating a second debug trace message that includes a timestamp, an index identifying the register in the set of instrumented trace registers, and a value written to the register in the set of instrumented trace registers; and storing the second debug trace message in the trace buffer. In the second aspect, the method may include, responsive to an external trigger signal from a component of an integrated circuit including the processor core that is outside of the processor core, generating a second debug trace message that includes a timestamp and a code indicating an event of the component; and storing the second debug trace message in the trace buffer. For example, the component may be a direct memory access controller and the event may be a start of a data transfer operation by the component. For example, the component may be a bus controller and the event may be a bus error. In the second aspect, the method may include, transmitting contents of the trace buffer to a host device via a debug interface of an integrated circuit including the processor core. In the second aspect, the first debug trace message may include one or more performance counter values. The performance counter values may include a count of instructions executed. In the second aspect, the performance counters may be encoded in a floating point format.

In a third aspect, the subject matter described in this specification can be embodied in methods that include, responsive to a branch instruction being executed by a processor core, generating a first debug trace message including a timestamp generated using a Gray code counter and an address of the branch instruction; and storing the first debug trace message in a trace buffer. In the third aspect, the method may include, responsive to execution of an instruction matching a watchpoint by the processor core, generating a second debug trace message that includes a timestamp and an identifier of the watchpoint; and storing the second debug trace message in the trace buffer. In the third aspect, the method may include responsive to a write to a register in a set of instrumented trace registers, generating a second debug trace message that includes a timestamp, an index identifying the register in the set of instrumented trace registers, and a value written to the register in the set of instrumented trace registers; and storing the second debug trace message in the trace buffer. In the third aspect, the method may include, responsive to an external trigger signal from a component outside of the processor core, generating a second debug trace message that includes a timestamp and a code indicating an event of the component; and storing the second debug trace message in the trace buffer. For example, the component may be a direct memory access controller and the event may be a start of a data transfer operation by the component. For example, the component may be a bus controller and the event may be a bus error. In the third aspect, the method may include transmitting contents of the trace buffer to a host device via a debug interface of an integrated circuit that includes the processor core. In the third aspect, the first debug trace message may include one or more performance counter values. The performance counter values may include a count of instructions executed. In the third aspect, the performance counters may be encoded in a floating point format.

In a fourth aspect, the subject matter described in this specification can be embodied in an integrated circuit for executing instructions that includes a processor core configured to execute instructions; a Gray code counter; a trace buffer configured to store a sequence of debug trace messages; and a debug trace circuitry that is configured to: responsive to a branch instruction being executed by the processor core, generate a first debug trace message including a timestamp generated using the Gray code counter and an address of the branch instruction; and store the first debug trace message in the trace buffer. In the fourth aspect, the trace buffer may be SRAM. In the fourth aspect, the debug trace circuitry may be configured to: responsive to execution of an instruction matching a watchpoint by the processor core, generate a second debug trace message that includes a timestamp and an identifier of the watchpoint; and store the second debug trace message in the trace buffer. In the fourth aspect, the integrated circuit may include a set of instrumented trace registers, and the debug trace circuitry may be configured to: responsive to a write to a register in the set of instrumented trace registers, generate a second debug trace message that includes a timestamp, an index identifying the register in the set of instrumented trace registers, and a value written to the register in the set of instrumented trace registers; and store the second debug trace message in the trace buffer. In the fourth aspect, the debug trace circuitry may be configured to: responsive to an external trigger signal from a component of the integrated circuit outside of the processor core, generate a second debug trace message that includes a timestamp and a code indicating an event of the component; and store the second debug trace message in the trace buffer. For example, the component may be a direct memory access controller and the event may be a start of a data transfer operation by the component. For example, the component may be a bus controller and the event may be a bus error. In the fourth aspect, the integrated circuit may be configured to: transmit contents of the trace buffer to a host device via a debug interface of the integrated circuit. In the fourth aspect, the first debug trace message may include one or more performance counter values. The performance counter values may include a count of instructions executed. In the fourth aspect, the performance counters may be encoded in a floating point format.

While the disclosure has been described in connection with certain embodiments, it is to be understood that the disclosure is not to be limited to the disclosed embodiments but, on the contrary, is intended to cover various modifications and equivalent arrangements included within the scope of the appended claims, which scope is to be accorded the broadest interpretation so as to encompass all such modifications and equivalent structures.

What is claimed is:

1. An integrated circuit for executing instructions comprising:
a processor core configured to execute instructions;
a data store configured to store codes indicating corresponding interrupt causes;
a trace buffer configured to store a sequence of debug trace messages; and
a debug trace circuitry that is configured to:
responsive to a first interrupt to the processor core, generate a first debug trace message including a timestamp and a code from the data store, the timestamp generated based on a coding technique, the code indicating a cause of the first interrupt; and
store the first debug trace message in the trace buffer, the first debug trace message accessible from the trace buffer to a host device.

2. The integrated circuit of claim 1, comprising:
a Gray code counter, wherein the timestamp is generated using the Gray code counter.

3. The integrated circuit of claim 1, wherein the data store is a register of the processor core.

4. The integrated circuit of claim 1, wherein the trace buffer is SRAM.

5. The integrated circuit of claim 1, wherein the first debug trace message includes one or more performance counter values, wherein the one or more performance counter values include a count of instructions executed.

6. The integrated circuit of claim 5, wherein the one or more performance counter values are encoded in a floating point format.

7. A method comprising:
receiving a first interrupt with a processor core;
writing a code indicating a cause of the first interrupt to a data store;
responsive to the first interrupt, generating a first debug trace message including a timestamp and the code from the data store, the timestamp generated based on a coding technique; and
storing the first debug trace message in a trace buffer, the first debug trace message accessible from the trace buffer to a host device.

8. The method of claim 7, further comprising:
responsive to execution of an instruction matching a watchpoint by the processor core, generating a second debug trace message that includes a timestamp and an identifier of the watchpoint; and
storing the second debug trace message in the trace buffer.

9. The method of claim 7, further comprising:
responsive to a write to a register in a set of instrumented trace registers, generating a second debug trace message that includes a timestamp, an index identifying the register in the set of instrumented trace registers, and a value written to the register in the set of instrumented trace registers; and
storing the second debug trace message in the trace buffer.

10. The method of claim 7, further comprising:
responsive to an external trigger signal from a component of an integrated circuit including the processor core that is outside of the processor core, generating a second debug trace message that includes a timestamp and a code indicating an event of the component; and
storing the second debug trace message in the trace buffer.

11. The method of claim 10, wherein the component is a direct memory access controller and the event is a start of a data transfer operation by the component.

12. The method of claim 10, wherein the component is a bus controller and the event is a bus error.

13. The method of claim 7, further comprising:
transmitting contents of the trace buffer to the host device via a debug interface of an integrated circuit including the processor core.

14. The method of claim 7, further comprising:
responsive to a branch instruction being executed by the processor core, generating a first debug trace message that includes a timestamp and an address of the branch instruction; and
storing the first debug trace message in the trace buffer.

15. The method of claim 14, wherein the timestamp is generated by using a Gray code counter.

16. A system comprising:
a processor core configured to execute instructions;
a Gray code counter;
a trace buffer configured to store a sequence of debug trace messages; and
a debug trace circuitry that is configured to:
responsive to a branch instruction being executed by the processor core, generate a first debug trace message including a timestamp generated using the Gray code counter and an address of the branch instruction; and
store the first debug trace message in the trace buffer, the first debug trace message accessible from the trace buffer to a host device.

17. The system of claim 16, wherein the branch instruction is a function call or a return.

18. The system of claim 17, wherein the debug trace circuitry is further configured to:
ignore other types of branch instructions as triggers for generating debug trace messages.

19. The system of claim 16, further comprising: a data store configured to store codes indicating corresponding interrupt causes.

20. The system of claim 19, wherein the debug trace circuitry is further configured to:
responsive to a first interrupt to the processor core, generate a second debug trace message including a second timestamp and a code from the data store, the code indicating a cause of the first interrupt; and
store the second debug trace message in the trace buffer.
